(19) United States
(12) Patent Application Publication
(10) Pub. No.: US 2011/0297664 A1
(43) Pub. Date: Dec. 8, 2011

(54) HIGH-FREQUENCY HEATING DEVICE

(75) Inventor: Mikio Fukui, Nara (JP)

(73) Assignee: PANASONIC CORPORATION, Kadoma-shi, Osaka (JP)

(21) Appl. No.: 13/201,361

(22) PCT Filed: Mar. 4, 2010
(86) PCT No.: PCT/JP2010/001499

§ 371 Date: Aug. 12, 2011

(30) Foreign Application Priority Data
Mar. 5, 2009 (JP) 2009-051719

(51) Int. Cl. H05B 3/02

(52) U.S. Cl. 219/220

(57) ABSTRACT

Including a first reflector plate (14) placed between a light source (13) and an illumination ring (12) placed around an operation dial (11), further including a second reflector plate (15) of which a reflecting surface is an angle different from that of the first reflector plate (14) and a third reflector plate (16) of which a reflecting surface is an angle different from that of the second reflector plate (15), in which a light from the light source (13) is shaded and reflected by the first reflector plate (14) and further reflected by the second reflector plate (15) and the third reflector plate (16), evenly illuminating the illumination ring (12).

### TECHNICAL FIELD

This present invention relates to a high-frequency heating device equipped with an operational dial.

### BACKGROUND ART

An ordinary high-frequency heating device is publicly disclosed in Japanese Patent Unexamined Publication No. 2004-198076, for example. FIG. 3 is a cross-sectional view of a control panel of the conventional high-frequency heating device. As shown in FIG. 3, illumination ring 2 is placed around operational dial 1. Behind illumination ring 2, light source 3 is placed. Light source 3 emits a direct light as indicated by an arrow. The direct light emitted by light source 3 illuminates illumination ring 2.

With the conventional constitution, however, since illumination ring 2 is illuminated by the direct light, a part near light source 3 is brighter and a part distant from the light source is dimmer. Namely, the illumination ring is not evenly illuminated, leaving a problem.

### SUMMARY OF THE INVENTION

The present invention aims to solve above ordinary problem and provide a high-frequency heating device in which an illumination ring placed around an operation dial of a control panel is evenly and inexpensively illuminated.

The high-frequency heating device of the present invention is composed of a heat chamber for housing an object to be heated, a high-frequency generator for generating a high frequency wave to heat the object to be heated, and a control panel for controlling the high-frequency generator. The control panel includes an operation dial, an illuminating ring placed around the operation dial, and a light source for illuminating the illumination ring. The present invention also includes a first reflector plate placed between the light source and the illumination ring for shading the illumination ring from a direct light. The device further includes a second reflector plate having a reflecting surface facing a different angle from a reflecting surface of the first reflector plate and a third reflector plate having a reflecting surface facing a different angle from the reflecting surface of the second reflector plate.

With this constitution, the illumination ring placed around the operation dial is illuminated evenly and inexpensively.

### BRIEF DESCRIPTION OF THE DRAWINGS

FIG. 1 is a perspective view of a high-frequency heating device according to a first exemplary embodiment of the present invention.

FIG. 2 is a cross-sectional view of a control panel of the high-frequency heating device according to the first exemplary embodiment of the present invention.

FIG. 3 is a cross-sectional view of a control panel of a conventional high-frequency heating device.

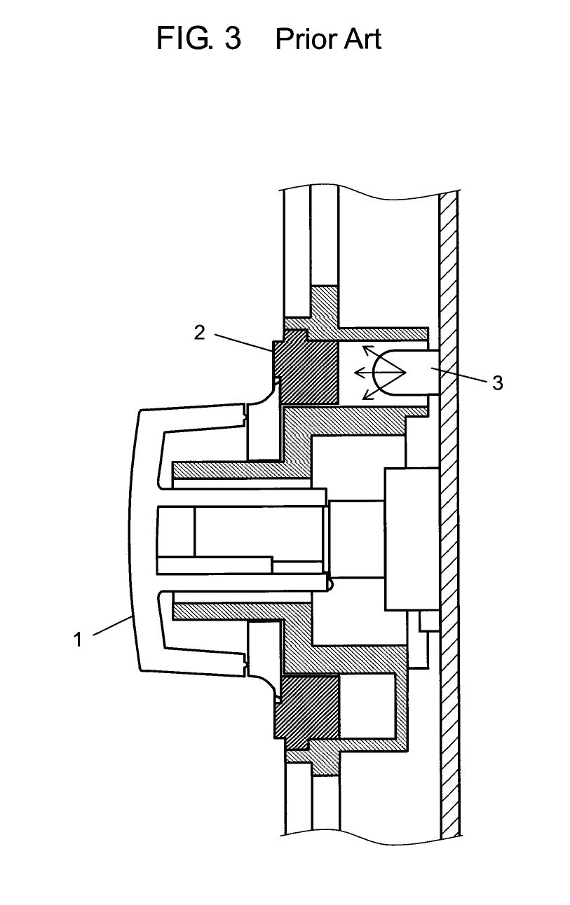

### DETAILED DESCRIPTION OF THE PREFERRED EMBODIMENTS

### First Exemplary Embodiment

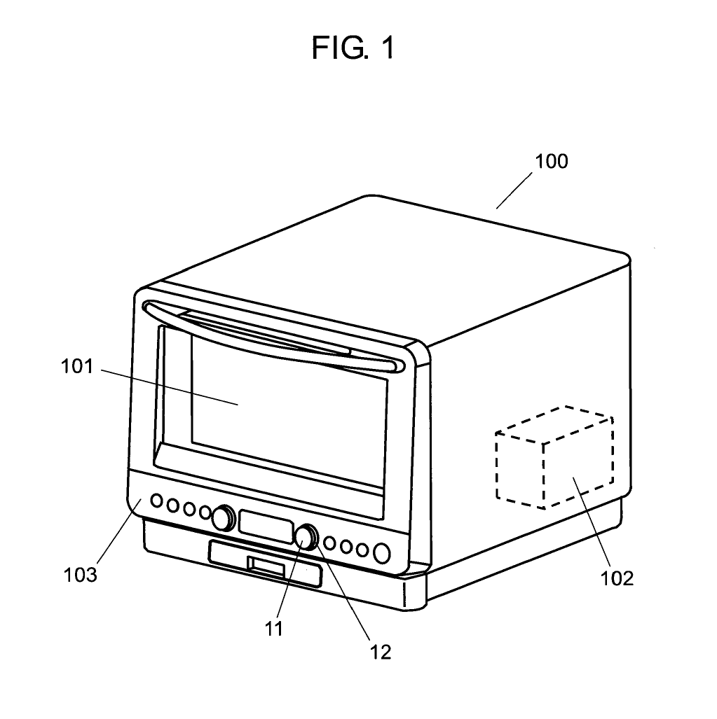

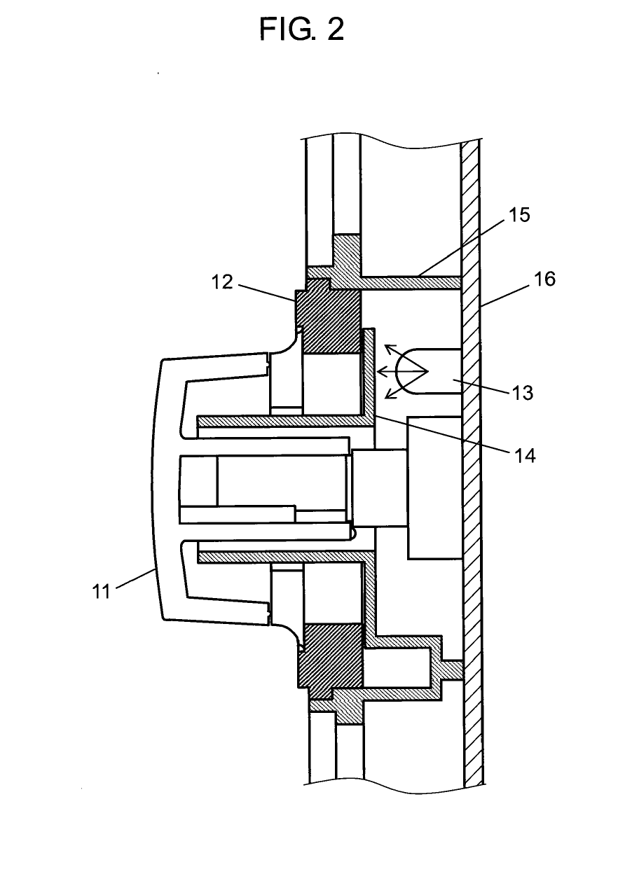

FIG. 1 is a perspective view of a high-frequency heating device of a first exemplary embodiment of the present invention. FIG. 2 is a cross-sectional view of a control panel of the high-frequency heating device according to the first exemplary embodiment of the present invention.

FIG. 1 shows that high-frequency heating device 100 is composed of heat chamber 101 for housing an object to be heated, high-frequency generator 102 for generating a high frequency wave to heat the object to be heated, and control panel 103 for controlling the high-frequency generator. Control panel 103 includes operation dial 11.

FIG. 2 shows that illumination ring 12 is placed around operation dial 11, light source 13 is placed behind illumination ring 12, and light source 13 emits a direct light as indicated by an arrow.

First reflector plate 14 is placed between light source 13 and illumination ring 12. A direct light emitted toward first reflector plate 14 is reflected by first reflector plate 14 to be diffused. Namely, first reflector plate 14 shades illumination ring 12 from the direct light. An angle of a reflecting surface of second reflector plate 15 is 90° different from that of first reflector plate 14. An angle of a reflecting surface of third reflector plate 16 is 90° different from that of second reflector plate 15.

Thus, the direct light emitted by light source 13 is shaded, reflected and diffused by first reflector plate 14, not directly illuminating illumination ring 12. The reflecting surface of second reflection plate 15 is 90° different from the reflecting surface of first reflector plate 14 and the reflecting surface of third reflector plate 16 is 90° different from the reflecting surface of second reflector plate 15. With this arrangement, the direct light emitted by light source 13 is diffused, becoming a uniform light to illuminate illumination ring 12.

With this constitution, the illumination ring placed around operation dial 11 of control panel 103 is illuminated evenly. Further, because constituent components are only first, second and third reflector plates 14, 15 and 16, high-frequency heating device 100 is simple in structure and is manufactured inexpensively.

### INDUSTRIAL APPLICABILITY

As demonstrated above, the present invention evenly illuminates an illumination ring with a simple structure, which may be applied to an operation dial of a heat cooker.

### REFERENCE MARKS IN THE DRAWINGS

11 operation dial

12 illumination ring

13 light source

14 first reflector plate

15 second reflector plate

16 third reflector plate

100 high-frequency heating device

101 heat chamber

102 high-frequency generator

103 control panel

1. A high-frequency heating device comprising:
a heat chamber for housing an object to be heated;
a high-frequency generator for generating a high frequency wave to heat the object to be heated; and
a control panel for controlling the high-frequency generator,
wherein the control panel includes an operation dial, an illumination ring placed around the operation dial, and a light source for illuminating the illumination ring,
wherein the control panel further includes a first reflector plate placed between the light source and the illumination ring, for shading the illumination ring from a direct light,
a second reflector plate having a reflecting surface facing a different angle from a reflecting surface of the first reflector plate; and
a third reflector plate having a reflecting surface facing a different angle from the reflecting surface of the second reflector plate.
